(19) United States
(12) Patent Application Publication
(10) Pub. No.: US 2011/0286669 A1
(43) Pub. Date: Nov. 24, 2011

(54) FORM PROCESSING SYSTEM, OCR DEVICE, FORM CREATION DEVICE, AND COMPUTER READABLE MEDIUM

(75) Inventors: Shoichi HAGISAWA, Ishikawa (JP); Go DOJO, Ishikawa (JP); Toshihiko SUGITA, Ishikawa (JP); Yoshinori KUWAMURA, Ishikawa (JP)

(73) Assignee: PFU LIMITED, Ishikawa (JP)

(21) Appl. No.: 13/112,884

(22) Filed: May 20, 2011

(30) Foreign Application Priority Data
May 24, 2010 (JP) 2010-118807
Oct. 12, 2010 (JP) 2010-230109

(51) Int. Cl. G06K 9/18

(52) U.S. Cl. 382/182

(57) ABSTRACT

There is provided a form processing system including a form creation device and an OCR device, wherein the form creation device includes a layout generation unit that generates layout information denoting a layout of a form and a layout transmission unit that transmits the layout information generated to the OCR device, and the OCR device includes a layout acquisition unit that acquires the layout information transmitted from the form creation device and an OCR processing unit that performs OCR processing on image data of the form read by a scanner, based on the layout information acquired.

### CROSS-REFERENCE TO RELATED APPLICATIONS

This application is based on and claims priority under 35 USC 119 from Japanese Patent Application No. 2010-118807 filed May 24, 2010 and Japanese Patent Application No. 2010-230109 filed Oct. 12, 2010.

### BACKGROUND OF THE INVENTION

### 1. Field of the Invention

The present invention relates to a form processing system, OCR device, form creation device, and computer readable medium.

### SUMMARY OF THE INVENTION

According to an aspect of the invention, there is provided a form processing system including a form creation device and an OCR device, wherein the form creation device includes a layout generation unit that generates layout information denoting a layout of a form and a layout transmission unit that transmits the layout information generated to the OCR device, and the OCR device includes a layout acquisition unit that acquires the layout information transmitted from the form creation device and an OCR processing unit that performs OCR processing on image data of the form read by a scanner, based on the layout information acquired.

### BRIEF DESCRIPTION OF THE DRAWINGS

Exemplary embodiments of the present invention will be described in detail based on the following figures, wherein:

FIG. 1 is an explanatory diagram showing outlined connections in a form processing system;

FIG. 2 is a functional block diagram showing a configuration of a form creation device;

FIG. 3 is an explanatory view showing one example of a form layout;

FIG. 4 is an explanatory table of layout information (characteristics information and data attributes information);

FIG. 5 is an explanatory view of referential image data;

FIG. 6 is a functional block diagram showing a configuration of an OCR device;

FIG. 7 is an explanatory table of reform information;

FIG. 8 is a sequence diagram showing a flow of overall processing in testing of a form processing method; and

FIG. 9 is a sequence diagram showing a flow of overall processing in operation of the form processing method.

### DESCRIPTION OF THE PREFERRED EMBODIMENTS

The following will describe in detail an exemplary embodiment of the present invention with reference to the accompanying drawings. It is understood that dimensions, materials, and other specific numerals given in the present embodiment are illustrative of the present invention for ease of explanation unless otherwise specified and details contained therein are not to be construed as limitations on the present invention. It is to be noted that identical reference numerals are given to the essentially the identical components in the present specification and drawings, and description thereof will not be repeated here.

(Form Processing System 100)

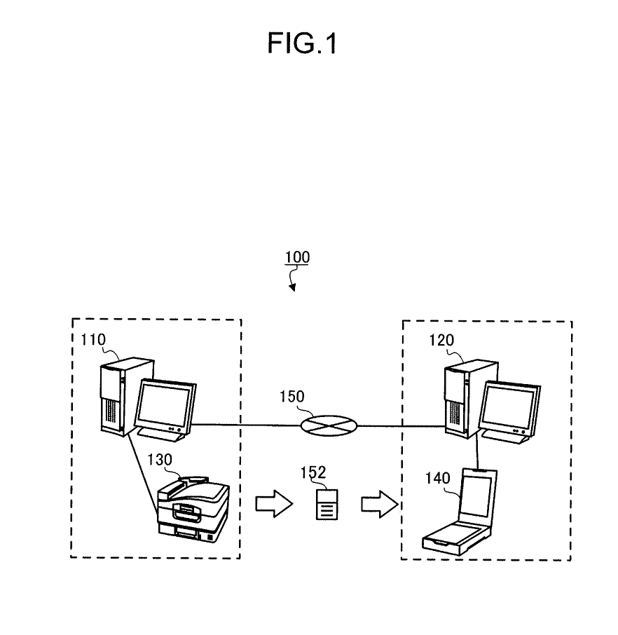

FIG. 1 is an explanatory diagram showing outlined connections in the form processing system 100. The form processing system 100 includes a form creation device 110, an OCR device 120, a printer 130, and a scanner 140. The form creation device 110 is connected with the OCR device 120 via a communication network 150 such as the internet, a local area network (LAN), or a dedicated line. The form creation device 110 is also connected with the printer 130 and the OCR device 120 is connected with the scanner 140 via, for example, the LAN.

If having received a user's input for creation of a layout, the form creation device 110 generates layout information (information about layout) that denotes the layout of a form 152. Then, the printer 130 prints the form 152 having the generated layout information. The user writes down, for example, job-related information onto the printed-out form 152 by handwriting, imprinting, or stamping. If the form 152 is completed in writing, the scanner 140 reads the form 152 having the information written on it, which image data then undergoes OCR processing in the OCR 120, which thereby acquires the information written on the form 152.

For example, a form creation device is proposed that automatically generates a format of the form in accordance with the model of the OCR device, the number of line fields, and the number of characters entered manually by the user. However, such a form creation device only automatically adjusts the character frame and the form size of a form to be created, leading to a troublesome job of identifying the OCR device model etc. Furthermore, in the case of reading forms of the same layout repeatedly, the user must notify the OCR device of, for example, a position at which a target form is read, in order to improve the accuracy in OCR processing.

Further, the accuracy in OCR processing can be improved also by comparing the image data read by the scanner 140 and to be subject to the OCR processing and image data to be referenced in OCR processing (hereinafter referred to as referential image data) to each other and correcting displacement and tilting in the image data.

To generate such referential image data, for example, such means are conceivable as to read a printed form 152 with the scanner 140 so that the user may determine portions where characters, ruled lines, etc. to be printed out can be varied by data and erase those portions in image processing to provide the referential image data or to print out the form 152 by using empty data as data relating to the variable portions so that the form 152 may be read with the scanner 140 to provide the referential image data.

For example, if there are portions where the accuracy in OCR processing may be deteriorated due to an influence of variations in density such as thinning of a color (including black) in printing on reading with the scanner 140, the former means would give the user a command to delete each of those portions, so that the user may find it difficult to determine which one of the portions is liable to be influenced by the variations in density, and also pose more work burdens.

The latter means cannot avoid the influence due to variations in density, so that the accuracy in OCR processing may be deteriorated in some cases. Further, the user needs to take the trouble of preparing empty data and outputting it as the form 152, resulting in more work burdens. Moreover, it is impossible to delete characters and symbols such as the output date/time, the page number, and the sequence number of the form 152 to be generated automatically.

Further, no matter which one of those means is used, the accuracy in OCR processing deteriorates if portions that vary with the different forms 152 remain in the generated referential image data. Further, in reading of the once printed form 152, if the form 152 is wrinkled or dust stuck to it, proper referential image data also cannot be obtained, so that the OCR processing accuracy may be deteriorated.

In the form processing system 100 according to the present embodiment, if layout information is generated by the form creation device 110, it is used also in OCR processing by the OCR 120 in common. In particular, in the case of using referential image data, the form creation device 110 generates referential image data not containing information unnecessary in correction of displacement or tilting and transmits it to the OCR device 120. Therefore, according to the present form processing system 100, it is possible to improve the accuracy in OCR processing while reducing work burdens on the user. The following will describe in detail the configurations of the form creation device 110 and the OCR device 120 in this order.

(Form Creation Device 110)

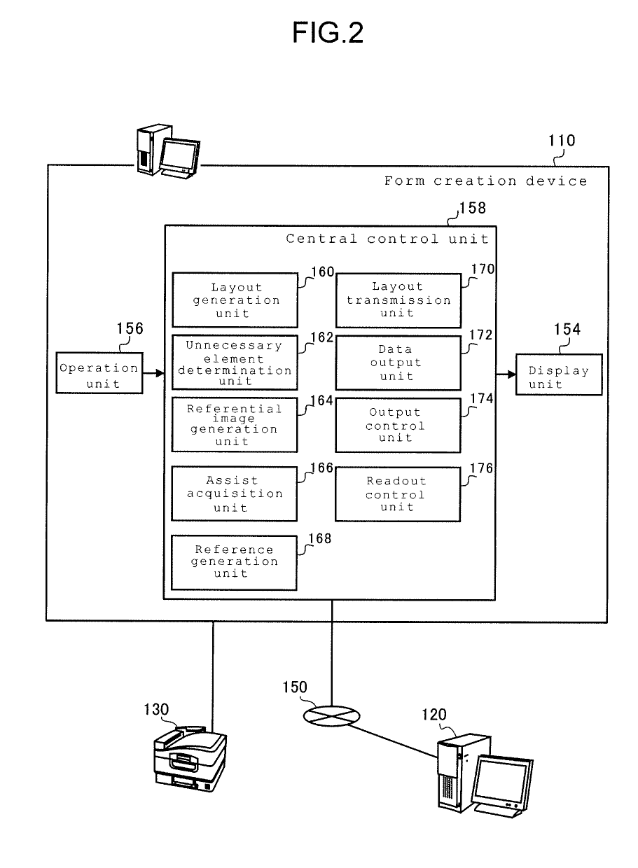

FIG. 2 is a functional block diagram showing the configuration of the form creation device 110. The form creation device 110 includes a display unit 154, an operation unit 156 and a central control unit 158.

The display unit 154 is constituted of an LCD, an organic electro luminescence display, etc. The operation unit 156 is constituted of a touch panel arranged on the display surface of the display unit 154, a keyboard mounted with a plurality of operation keys, a pointing device such as a mouse, an arrow key, or a joystick. The form creation device 110 displays a form creation screen on the display unit 154, to receive a user's input through the operation unit 156, thereby generating a layout of the form 152.

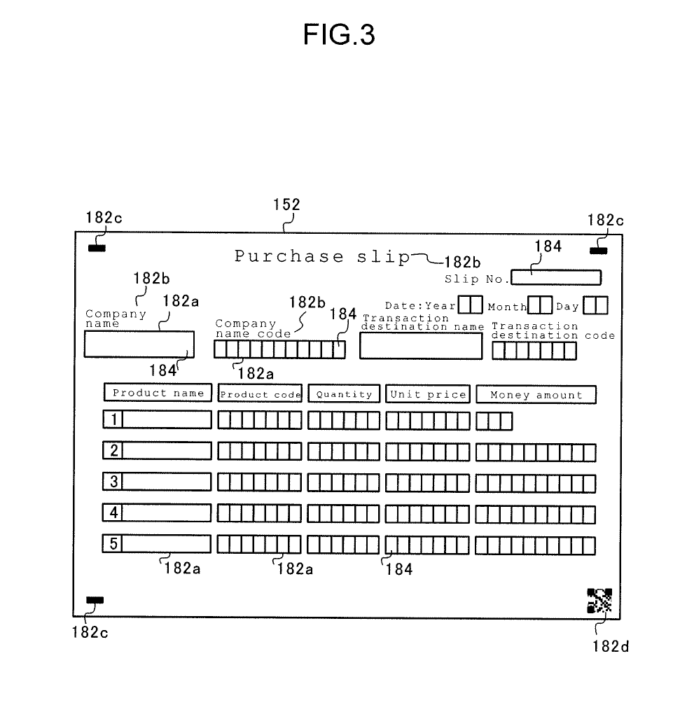

FIG. 3 is an explanatory view showing one example of a layout. As shown in FIG. 3, the layout of form 152, for example, a character frame 182a, a character 182b, a reference mark 182c, a barcode 182d is set. It is to be noted that the reference marks 182c provide references for the direction and layout position of the form 152 when the OCR device 120 performs OCR processing on image data read by the scanner 140. Further, the barcode 182d is obtained by encoding arbitrary information in accordance with predetermined rules and denotes, for example, a form ID that identifies the form 152.

The form creation device 110 generates a layout such as shown in FIG. 3 in response to user's input through the operation unit 156. In this case, the form 152 includes a plurality of input regions 184 summarizing input aspects with regularities. The input region 184 is enclosed by, for example, the character frame 182a. The input region 184 is capable of setting in it the type of characters (alphabet, number, Japanese, symbol, etc.), the attributes (handwritten character, type, etc.), etc. assumed to be written.

The central control unit 158 controls the entire form creation device 110 by using a semiconductor integrated circuit incorporating a central processing unit (CPU), an ROM storing a program etc., and an RAM serving as a working area, etc. Further, the central control unit 158 functions also as a layout generation unit 160, an unnecessary element determination unit 162, a referential image generation unit 164, an assist acquisition unit 166, a reference generation unit 168, a layout transmission unit 170, a data output unit 172, an output control unit 174, and a readout control unit 176.

The layout generation unit 160 generates layout information that denotes the layout of the form 152 in accordance with a layout set by a user's input through the operation unit 156.

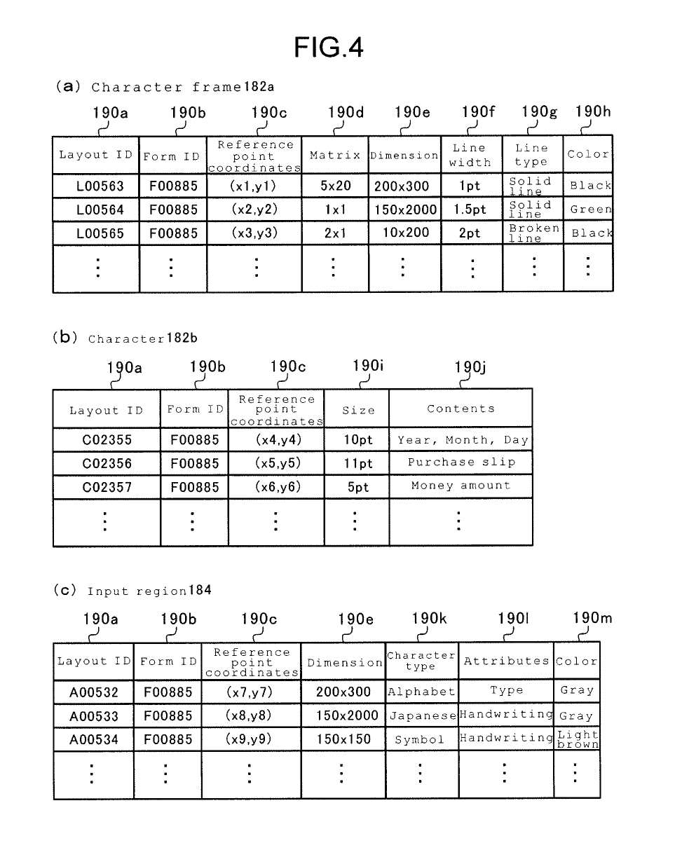

The layout information contains characteristics information and OCR attributes information. The characteristics information denotes layout characteristics such as comments (dictionary) and sets the position, the line type, etc. of, for example, a ruled line and a character. The OCR attributes information denotes the data attributes of a position subject to OCR processing (hereinafter referred to as OCR position) and a character, a symbol, etc. subject to this OCR processing. The following will describe the characteristics information and the OCR attributes information with reference to FIG. 4.

FIG. 4 is an explanatory table of layout information (characteristics information and data attributes information). In particular, FIG. 4A shows layout information (characteristics information) of the character frame 182a, FIG. 4B shows layout information (characteristics information) of the character 182b, and FIG. 4C shows layout information (OCR attributes information) of the input region 184. As shown in FIG. 4A, the layout information of the character frame 182a is made of, for example, a layout ID 190a, a form ID 190b, a reference point coordinate 190c, a matrix 190d, a dimension 190e, a line width 190f, a line type 190g, a color 190h, etc.

The layout ID 190a is identification information that identifies the corresponding character frame 182a. The form ID 190b is identification information that identifies layout information which the form 152 is based on. The reference point coordinate 190c denotes coordinates of a reference point of the corresponding character frame 182a, for example, the lower left point of the character frame 182a. In the present embodiment, the coordinate system has an x-axis and a y-axis as its horizontal and vertical directions respectively on the assumption that the lower left reference mark 182c of the form 152 is its origin. The matrix 190d denotes the respective numbers of rows and columns in a case where a region surrounded by the corresponding character frame 182a is subdivided. Further, the layout information (characteristics information) may set the character frame 182a not in table units but in units of a block obtained by subdividing the region surrounded by this character frame 182a.

The size 190e denotes, for example, the width and the height of a block obtained by subdividing a table surrounded by the character frame 182a and, if the width and the height differ with the different rows and columns, is set for each of the rows or columns. Similarly, if the line width 190f, the line type 190g, and the color 190h of the character frame 182a differ with the different rows and columns, they are set for each of the rows or columns. In this case, if the line width 190f, the line type 190g, and the color 190h of the character frame 182a are different between the adjacent rows or columns, in the sandwiched character frame 182a, priority is given to the settings that are later made by a user's input. Further, besides the character frame 182a closed by ruled lines on all four sides, the rules lines can be set independently.

As shown in FIG. 4B, the layout information of the character 182b is made of, for example, the layout ID 190a, the form ID 190b, the reference point coordinate 190c, a size 190i, a content 190j, etc. The size 190i denotes the size of the character 182b and the content 190j is the character 182b itself actually printed, such as “purchase slip”, “year”, “month, or “day”. Further, if the character 182b is variable because it happens to be, for example, a sequential slip number or a customer number which is different with each customer, the layout information may contain variable information that denotes change rules of the character 182b.

As shown in FIG. 4C, the layout information of the input region 184 is made of, for example, the layout ID 190a, the form ID 190b, the dimension 190e, a character type 190k, an attribute 190l, a color 190m, etc. The character type 190k denotes, as described above, the type of a character assumed to be written and can set, for example, an alphabet, a number, a Hiragana, a Katakana, a symbol, Japanese, etc. The attribute 190l can set a handwritten character if handwriting is employed in writing, a type if printing or data sealing is employed, etc.

The layout information (characteristics information and data attributes information) shown in FIG. 4 is just one example and contains the reference mark 182c and the barcode 182d as well as various information settings of various elements that can be written in the form 152. Further, for example, the characteristics information may be expressed in various data formats including, for example, the page description language (PDL).

The aforementioned referential image data is image data obtained by imaging (rasterizing) a layout set by a user's input in a bitmap format etc. by use of, for example, the RGB or MYK color specification system. However, only by imaging the layout, the OCR processing accuracy may be deteriorated due to an influence of, for example, the aforementioned portions where the density varies in printing or readout by use of the scanner 140 or the variable portions that change with each of the forms 152 such as characters and symbols of the form 152's output date/time, page number, and sequence number that are generated automatically. To solve this problem, the form creation device 110 in the present embodiment is equipped with the unnecessary element determination unit 162.

It is to be noted that although the referential image data in the present embodiment will be described with a specific example of a case where it is image data in the bitmap format that accommodates all the types of forms, the referential image data is not limited to it. It may be image data which is a part of the form (characteristic partial image of a logo or large character) or a combination of those partial image data and sets of metadata thereof. That is, the referential image data according to the present invention may include image data of the entire form, partial image data contained in a form, and partial image data contained in a form and its attributes information (position or image type).

The unnecessary element determination unit 162 determines unnecessary image elements among layout information. Based on the layout information, the referential image generation unit 164 generates referential image data from which image elements are removed which are determined as unnecessary by the unnecessary determination unit 162 (on which an imaging flag is false), by referencing, for example, the imaging flag that is given for each image element by the unnecessary element determination unit 162 and denotes whether imaging is available or not. In the present embodiment, the image elements refer to information that corresponds to individual items such as the character frame 182a, the character 182b, the reference mark 182c, and the barcode 182d shown in FIG. 3 among the layout information.

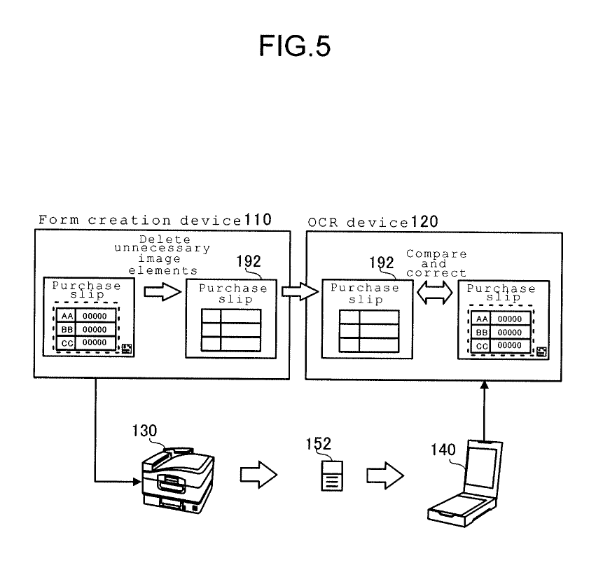

FIG. 5 is an explanatory view of the referential image data. In the form creation device 110, the unnecessary element determination unit 162 sets the imaging flag true on the image elements of, for example, fixed literals (characters) such as an “invoice” and a “purchase slip”, solid ruled lines or character frames, and a white color (expressed as (255, 255, 255) in the RGB color specification system) or a black color (expressed as (0, 0, 0) in the RGB color specification system) because they will not deteriorate the OCR processing accuracy.

Further, the image elements determined as unnecessary by the unnecessary element determination unit 162 may include variable character strings or number strings, dotted lines, broken lines, gray and other color fills, hatchings, pattern images of barcodes etc., gray and other color image elements, lines thinner than a predetermined rated value, and characters smaller than a predetermined rated value. Those image elements may have moirés in some cases because differences would occur in line thickness, resolution, color, and halftone dot structure in the referential image data to be generated owing to factors such as a difference in performance and processing of the printer 130 and the scanner 140. The unnecessary element determination unit 162 turns the imaging flag false on those image elements. Such a configuration enables to remove from the referential image data more securely the image elements that deteriorate the OCR processing accuracy.

As shown in FIG. 5, the referential image generation unit 164 in the form creation device 110 generates the referential image data 192 from which the image elements determined as unnecessary by the unnecessary element determination unit 162, in this case, broken lines, variable character strings, and barcodes are removed. Thus generated referential image data 192 is then transmitted to the OCR device 120. A later-described image correction unit in the OCR device 120 corrects displacement and tilting on the referential image data 192 and image data of the form 152 read by the scanner 140.

Such a configuration that the OCR device 120 may perform OCR processing based on the referential image data from which unnecessary image elements are removed avoids a situation that variable portions that change with each of the forms 152 would remain in the referential image data owing to a user's mistake in decision etc., thereby improving the OCR processing accuracy. Further, the configuration eliminates the need for instructing to delete each of the unnecessary image elements or to prepare empty data, thereby greatly reducing work burdens on the user.

Moreover, the form creation device 110 in the present embodiment has higher accuracy in OCR processing because it is less affected by wrinkles in the form 152 and dust stuck to the form 152 than the case of reading the form 152 once printed and generating referential image data.

Further, based on the layout information, the referential image generation unit 164 rasterizes only the image elements from which the image elements determined by the unnecessary element determination unit 162 as unnecessary are removed. Accordingly, it is possible to reduce processing burdens on the referential image generation unit 164 by the processing to rasterize the unnecessary image elements as compared to the case of rasterizing all the image elements and then deleting the unnecessary image elements from the referential image data.

The assist acquisition unit 166 acquires assist information transmitted from the later-described OCR device 120. If the assist acquisition unit 166 has acquired assist information, the layout generation unit 160 can generate layout information based on the assist information. The assist information contains algorithm information about an algorithm used in the OCR processing unit in the OCR device 120, which information may be, for example, the model name of the OCR device 120 or the name or version of OCR processing software used in the OCR processing unit in the OCR device 120.

The layout generation unit 160 applies restrictions on the layout information in accordance with the algorithm information acquired by the assist acquisition unit 166. For example, in the case of allocating the character frame 182a in accordance with a user's input, the layout generation unit 160 provides a lower limit value on the line width 190f of that character frame 182a. If the algorithm information is the name and the version of the OCR processing software, this lower limit value is set based on a performance of an algorithm identified by those OCR processing software and version.

Similarly, based on the algorithm information, the layout generation unit 160 applies restrictions on set items such as the size 190i and the location (reference point coordinate 190c) of the reference mark 182c, the size 190i of the barcode 182d, a dropout color not read by the scanner 140, the character type 190k, and the attribute 190l. Further, if the location of elements such as the character frame 182a is instructed by the user, the layout generation unit 160 may set on the basis of the algorithm information the initial values of the aforementioned set items contained in the layout information of those elements.

This configuration employing algorithm information reduces the number of times of repeating operations to conduct tests for confirmation of the accuracy in OCR processing on the form 152 and modifying the layout information based on the test results of the OCR processing, thereby greatly mitigating the work burdens on the user.

The reference generation unit 168 generates reference data that provides a reference for comparison to the results of OCR processing in the OCR device 120, based on the layout information generated by the layout generation unit 160. The reference data will be described later.

The layout transmission unit 170 transmits the layout information and the reference data to the OCR device 120. Further, the layout transmission unit 170 transmits to the OCR device 120 referential image data from which the image elements are removed which are determined by the unnecessary element determination unit 162 as unnecessary. The data output unit 172 provides the printer 130 with the layout information after converting it into a format appropriate for printing out.

In a case where the form 152 is to be printed, the output control unit 174 controls the printer 130 so that it may print under predetermined printing conditions. Not limited to the case of directly controlling the printer 130, the output control unit 174 may provide the printer 130 with control information such as printing conditions that prohibits changes so that the printer 130 can set the printout conditions based on the control information.

If, for example, reduced printing is conducted owing to a careless change in printout conditions in the printer 130, the OCR processing accuracy may possibly be deteriorated due to a reduction in character size or line width in the printed form 152. Such a situation can be avoided by the output control unit 174 conducting control on the printer 130 so that it may perform printing under the predetermined printout conditions.

The readout control unit 176 provides the scanner 140 with specification information that specifies a resolution with which the scanner 140 reads the form 152 to convert it into image data as well as an application and commands to be executed after the readout, through the communication network 150. Not limited to such a case of providing through the communication network 150, the readout control unit 176 may embed the specification information in the form 152 as, for example, the barcode 182d so that the scanner 140 can acquire this specification information from that barcode 182d.

By such a configuration of including the readout control unit 176, it is possible to generate image data at a resolution appropriate for the OCR processing and to correct the generated image data by using applications and commands of the scanner 140, thereby further improving the OCR processing accuracy.

(OCR Device 120)

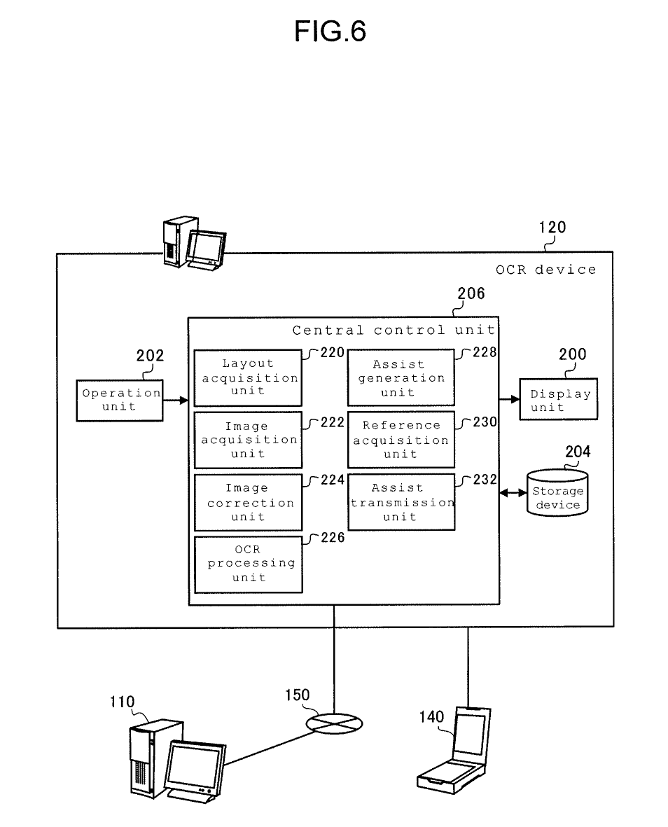

FIG. 6 is a functional block diagram showing a configuration of the OCR device 120. The OCR device 120 includes a display unit 200, an operation unit 202, a storage device 204 and a central control unit 206.

The display unit 200 is constituted of an LCD, an organic EL display, etc. The operation unit 202 is constituted of a touch panel mounted on a display surface of the display unit 200, a keyboard mounted with a plurality of operation keys, a pointing device such as a mouse, an arrow key, or a joystick.

The storage device 204 stores layout information etc., being constituted of a hard disk drive (HDD), a flash memory, a nonvolatile random access memory (RAM), etc. In the present embodiment, the storage device 204 is formed integrally with the OCR device 120 but not restricted to this aspect and may be, for example, a separate network attached storage (NAS) or an external HDD or universal serial bus (USB) memory.

The central control unit 206 controls the entire OCR device 120 by using a semiconductor integrated circuit incorporating a central processing unit (CPU), an ROM storing a program etc., and an RAM serving as a working area, etc. Further, the central control unit 206 functions also as a layout acquisition unit 220, an image acquisition unit 222, an image correction unit 224, an OCR processing unit 226, an assist generation unit 228, a reference acquisition unit 230, and an assist transmission unit 232.

The layout acquisition unit 220 acquires layout information or referential image data transmitted from the form creation device 110 and stores it in the storage device 204.

The image acquisition unit 222 acquires image data generated by reading the form 152 from the scanner 140.

If the layout acquisition unit 220 has received referential image data beforehand, the image correction unit 224 corrects displacement and tilting in image data of the form 152 read by the scanner 140 based on the referential image data stored in the storage device 204. In the processing to correct displacement and tilting, if, for example, the referential image data corresponds to the entire form, the image correction unit 224 compares the image data read by the scanner 140 and the referential image data and corrects the read image data so that its degree of agreement with the referential image data may increase and, if the referential image data contains partial image data of the form and its attributes information (position and type), corrects the read image data so that image elements contained in the image data read by the scanner 140 may agree with the image data contained in the referential image data. The referential image data stored in the storage device 204 is correlated with, for example, a form ID of the form 152, so that the image correction unit 224 can refer to the referential image data that corresponds to the image data of the generated form 152.

It is to be noted that the referential image data not only provides a reference for the displacement and tilting correction processing but also used as information that identifies the form (that is, information (form ID) that identifies the layout information). That is, the storage device 204 may be configured to store layout information beforehand in a state where it is correlated with referential image data, and the OCR processing unit 226 may be configured to compare image data of the form read by the scanner 140 to the referential image data stored beforehand and conduct OCR processing on the read form image data by using the layout information correlated with the referential image data that agrees with this form image data most.

Further, although the present embodiment has employed the configuration in which the form creation device 110 would be equipped with the unnecessary element determination unit 162 and the referential image generation unit 164 so that referential image data generated in the form creation device 110 might be received by the OCR device 120, such a configuration may be employed that the OCR device 120 would be equipped with the unnecessary element determination unit 162 and the referential image generation unit 164.

The OCR processing unit 226 reads the form 152's form ID described in the shape of the barcode 182d etc., by using as a reference, for example, the position of the reference mark 182c in an image given by the image data acquired by the image acquisition unit 222. Further, the OCR processing unit 226 reads the layout information containing that form ID from the storage device 204 and, based on the read layout information, conducts OCR processing on the image data of the form 152 read by the scanner 140 (processing to extracts contents such as characters and numbers denoted by the image data from this image data).

The OCR device 120 in the present embodiment conducts OCR processing based on layout information acquired from the form creation device 110, so that it is possible to know, for example, a position of the character frame 182a and a position at which the written information is read, thereby improving the accuracy in OCR processing. Moreover, as compared to a case where, for example, the printed form 152 is read with the scanner 140 to generate image data so that displacement and tilting may be corrected based on the image data, the OCR device 120 that conducts OCR processing based on the layout information and the referential image data is not affected by dust stuck to the form 152 or wrinkles in the form 152, so that the accuracy in OCR processing is improved. Further, the layout information generated in the form creation device 110 is used also in the OCR device 120 in common, so that the user need not perform the same setting both in the form creation device 110 and the OCR device 120 and so is relieved of heavy work burdens. Moreover, also in the case of modifying the layout information in order to meet a need to improve the OCR processing accuracy based on specification changes and the results of the OCR processing for the once printed form 152, similarly, the layout information modified in the form creation device 110 can be used in both of the form creation device and the OCR device 120, thereby mitigating the work burdens on the user.

Further, the layout information contains variable information that defines a variable form capable of changing, for example, the shape, the size 190i, the location, the number of subdivisions, etc. about the input region 184 in the form 152.

If no measures are taken in handling of such a variable form, the OCR processing unit 226 will have to estimate its input region 184 based on only the image data, so that appropriate OCR results cannot be obtained in some cases. To solve this problem, in the present embodiment, if the form creation device 110 has determined the shape, the size 190i, the location, the number of subdivisions, etc. of the variable information input region 184 in the layout information in response to a user's input and then the data output unit 172 has output to the printer 130 the layout information containing the determined variable information input region 184, the layout transmission unit 170 is triggered by the output by the data output unit 172, to transmit to the OCR device 120 the layout information containing the determined input region 184. Further, in a case where the printer 130 is to determine the shape, the size 190i, the location, the number of subdivisions, etc. of the input region 184, the layout transmission unit 170 may be triggered by actual printout of the form 152 from the printer 130, to transmit the layout information containing this determined input region 184 to the OCR device 120.

In such a configuration, the OCR device 120 has a decided input region 184 in the layout information, so that it is possible to improve the OCR accuracy based on the accurate information of the input region 184 and reduce processing loads because the OCR processing target regions can be narrowed down.

Further, the layout information in this case may be the aforementioned referential image data of the layout of the form 152 in accordance with the user's input. For example, the OCR device 120 corrects the image data of the form 152 read with the scanner 140 by matching, for example, its ruled line position etc. with the referential image data, which is the layout information also, and then conducts OCR processing on it. Such a configuration also improves the accuracy in OCR processing.

The assist generation unit 228 generates assist information that assists generation of layout information. The generated assist information contains also reform information that denotes points to be reformed in the layout information. The algorithm information among the assist information has been described already, so that the following will describe in detail the reform information.

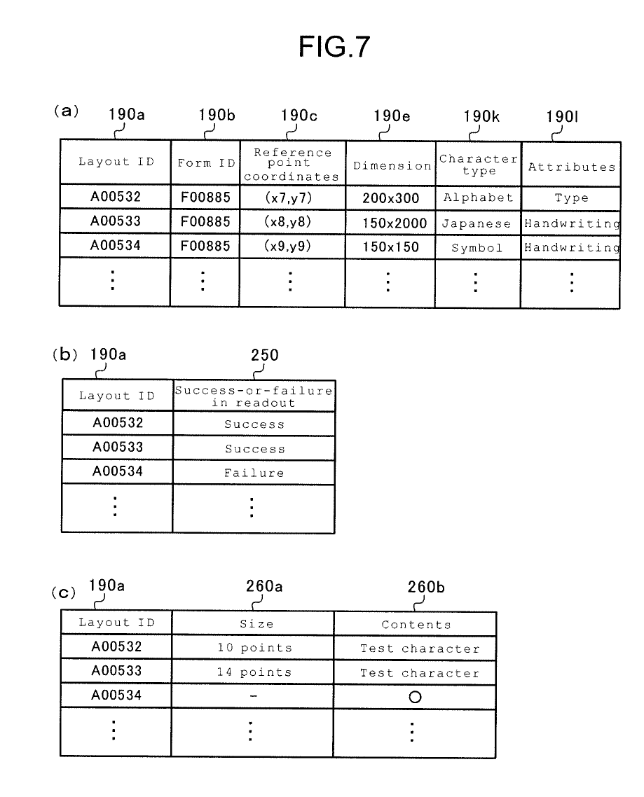

FIG. 7 is an explanatory table of reform information. In particular, FIG. 7A shows one example of the layout information, FIG. 7B shows one example of the reform information, and FIG. 7C shows one example of the reference data.

The assist generation unit 228 refers to such layout information about the input region 184 as shown in, for example, FIG. 7A, which has been acquired by the layout acquisition unit 220. Such layout information has already been described with reference to FIG. 4C, and repetitive description on it will be omitted.

Further, the assist generation unit 228 confirms whether written information is read successfully (success-or-failure in readout), which is denoted in the referenced layout information as a result of OCR processing by the OCR processing unit 226, about the subdivided input region 184 in which the written information should be able to be read. For example, in the case of reading handwritten characters, the OCR processing unit 226 crosschecks them against a reference character registered in the OCR processing software to compare a predetermined threshold value and an index value that denotes the degree of agreement with the characters decided to be most agreed with the reference character, thereby deciding the success-or-failure in readout. The threshold value can be changed through a user's input.

As shown in FIG. 7B, the assist generation unit 228 generates reform information that correlates the layout ID 190a which denotes the subdivided input region 184 in the layout information and the success-or-failure in readout (success-or-failure-in-readout 250) with each other, based on the results of the OCR processing.

In such a manner, as a result of OCR processing, for example, the reform information denotes a failure in readout in the subdivided input region 184 in which written information should originally be able to be read. Based on the reform information, the layout generation unit 160, for example, fills with a red color the subdivided input region 184 in which readout failed or reddens the character frame 182a that surrounds this subdivided input region 184, thereby prompting the user for reformation. Then, in response to a user's input, the layout information is modified, for example, the input region 184 or the size 190i of the character 182b is increased, to improve the accuracy in OCR processing.

In such a configuration of using the reform information, the success-or-failure in readout of written information is automatically presented, to eliminate the need for confirming it for each of the input regions 184, thereby mitigating the work burdens on the user and also avoiding a situation of overlooking points that need to be reformed.

Further, reference data generated by the reference generation unit 168 in the aforementioned form creation device 110 can be used to make the reform information more useful for the purpose of efficient reformation. The reference data generated by the reference generation unit 168 is not contained in the layout information and used in a test to confirm the accuracy in OCR processing. The reference data contains the layout ID 190a which denotes the subdivided input region 184 as well a size 260a of a character and a content 260b to be written by the user into the subdivided input region 184 for testing as shown in, for example, FIG. 7C.

In this case, a character having, for example, the size 260a or the content 260b defined in reference data beforehand is written into the subdivided input region 184 in the form 152. Further, besides handwritten characters, any character defined in the reference data may be printed with the printer 130. In this case, no matter whether the character is well written or not by the user, the OCR processing accuracy is improved by securely detecting a failure in readout caused by distortion etc. in an image generated by the scanner 140. Then, the image acquisition unit 222 in the OCR device 120 acquires the image data of that form 152 via the scanner 140.

The reference acquisition unit 230 acquires reference data transmitted by the layout transmission unit 170. The assist generation unit 228 generates reform information based on the reference data acquired by the reference acquisition unit 230 and the results of OCR processing.

The assist generation unit 228 generates reform information by comparing the reference data which denotes a character etc. whose, for example, size 260a or content 260b is defined and the results of OCR processing on image data of the form 152 in which characters etc. are actually written. The thus generated reform information is transmitted by the later-described assist transmission unit 232 to the form creation device 110. The form creation device 110 modifies layout information based on the reform information. In such a configuration to use the reference data, it is possible to conduct detailed comparison on character misrecognition etc., thereby improving accuracy in reformation of the layout information.

As described above, by using assist information such as the algorithm information and the reform information, information that can be known on the side of the OCR device 120 can be used in common also by the form creation device 110, so that the layout generation unit 160 in the form creation device 110 can generate layout information on which OCR processing can be performed easily.

The assist transmission unit 232 transmits assist information generated by the assist generation unit 228 to the form creation device 110.

The form creation device 110 and the OCR device 120 hereinbefore described improve the accuracy in OCR processing while greatly reducing work burdens on the user. Further, the present invention will provide a form generation program causing a computer to function as the form creation device 110, an OCR processing program causing it to function as the OCR device 120, and a computer-readable storage medium storing the form creation program or the OCR processing program such as a flexible disk, a magneto-optical disk, an ROM, an EPROM, an EEPROM, a compact disk (CD), a digital versatile disk (VDV), or a blue-ray disc (BD). Here, the program refers to data processing means described in an arbitrary language or description method.

Further, the form creation program and the OCR processing program may be stored in an arbitrary application program server connected to the form creation device 110 or the OCR device 120 via the communication network 150 so that all or part of them can be downloaded as required.

(Form Processing Method)

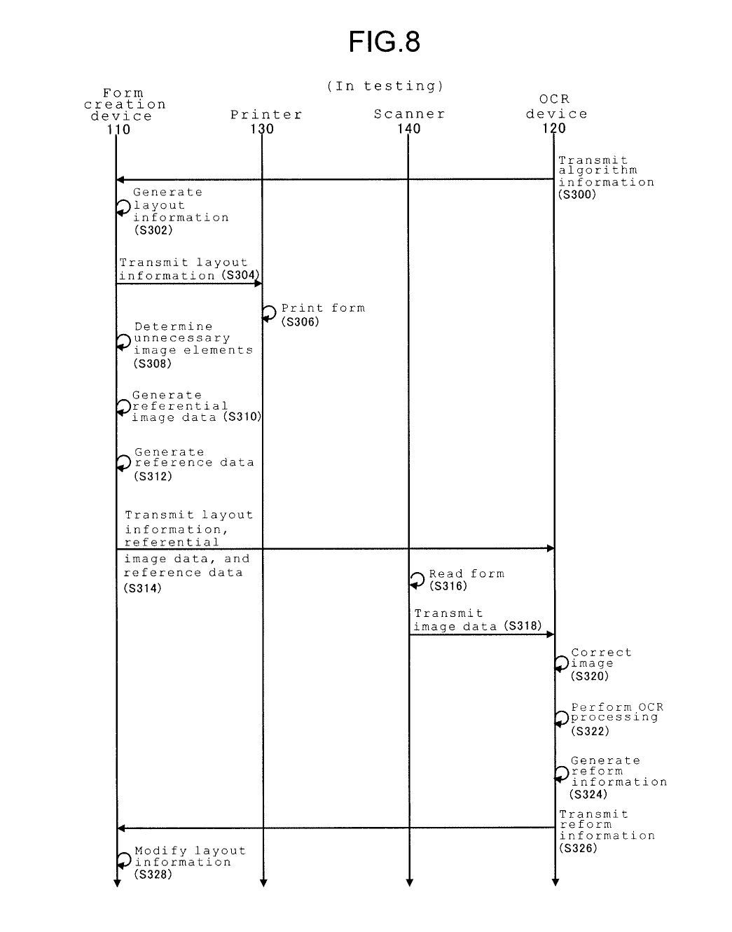

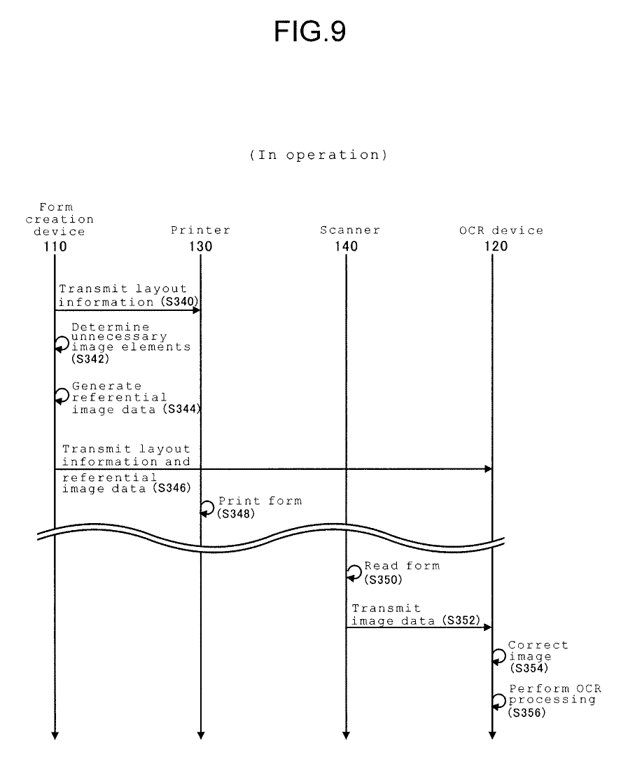

Next, a description will be given of the form processing method for operation of the aforementioned form processing system. FIG. 8 is a sequence diagram showing the flow of overall processing in testing of the form processing method and FIG. 9 is a sequence diagram showing the flow of overall processing in operation of the form processing method.

As shown in FIG. 8, if the OCR device 120 transmits assist information containing algorithm information to the form creation device 110 (S300), the form creation device 110 causes the layout generation unit 160 to generate the layout information that denotes a layout of the form 152 based on a user's input (S302). Then, in accordance with the input for printing the form 152, the data output unit 172 converts the layout information having the determined input region 184 into a printout-appropriate format and outputs it to the printer 130 (S304). The printer 130 prints the form 152 (S306). The unnecessary element determination unit 162 determines unnecessary image elements among the layout information (S306). The referential image generation unit 164 generates referential image data from which the image elements determined by the unnecessary element determination unit 162 as unnecessary are removed, based on the layout information (S310). Then, the reference generation unit 168 generates reference data based on the layout information having the determined input region 184 (S312). The layout transmission unit 170 transmits the layout information, the referential image data, and the reference data to the OCR device 120 (S314). The user writes a character etc. denoted by the reference data displayed, for example, on the display unit 154 and having the defined size 260a and content 260b.

After the information is written on the printed form 152, the scanner 140 reads the form 152 on which the information is written (S316) and transmits image data to the OCR device 120 (S318). The image correction unit 224 in the OCR device 120 corrects displacement and tilting in the image data generated by the scanner 140 by reading the form 152 based on the referential image data (S320). The OCR processing unit 226 performs OCR processing on the image data based on the layout information (S322). Then, the assist generation unit 228 generates reform information based on the results of the OCR processing and the reference data (S324). The assist transmission unit 232 transmits the reform information to the form creation device 110 (S326). The layout generation unit 160 in the form creation device 110 prompts the user for reformation based on the reform information so that the layout information may be modified (S328).

In operation, as shown in FIG. 9, in accordance with an input for printing of the form 152, the data output unit 172 in the form creation device 110 converts the layout information having the determined input region 184 into a printout-appropriate format and outputs it to the printer 130 (S340). The unnecessary element determination unit 162 in the form creation device 110 determines unnecessary image elements among the layout information (S342). The referential image generation unit 164 generates referential image data from which the image elements determined by the unnecessary element determination unit 162 as unnecessary are removed, based on the layout information (S344). The layout transmission unit 170 transmits the layout information and the referential image data to the OCR device 120 (S346). The printer 130 prints the form 152 (S348). The layout information of the form 152 at this point in time is assumed to have been modified on the basis of the reform information already through the form processing method shown in FIG. 8.

Then, the user describes job-related information on the form 152 by handwriting, the form 152 is read by the scanner 140 (S350), and the read image data is transmitted to the OCR device 120 (S352). Then the image correction unit 224 in the OCR device 120 corrects displacement and tilting in the image data generated by the scanner 14 by reading the form 152 based on the referential image data (S354). Then, the OCR processing unit 226 performs OCR processing on the corrected image data, to acquire the written information (S356). The layout of such image data is already modified in FIG. 8, thereby increasing the accuracy in OCR processing.

According to such a form processing method, both in testing shown in FIG. 8 and in operation shown in FIG. 9, it is possible to improve the accuracy in OCR processing by using layout information modified on the basis of reform information while mitigating work burdens on the user.

Although there has been hereinabove described the preferred embodiment of the present invention with reference to the accompanying drawings, of course, it should be appreciated that the present invention is not limited thereto. Accordingly, any and all modifications and variations which is conceivable to those skilled in the art should be considered to be within the scope of the present invention as defined in the appended claims.

It is to be noted that the steps in the form creation method in the present specification need not necessarily be performed in a time-series manner along the order described in the flowchart and may follow concurrent processing or subroutine-based processing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A form processing system comprising a form creation device and an OCR device, wherein the form creation device includes:
a layout generation unit that generates layout information denoting a layout of a form; and
a layout transmission unit that transmits the layout information generated to the OCR device, and
the OCR device includes:
a layout acquisition unit that acquires the layout information transmitted from the form creation device; and
an OCR processing unit that performs OCR processing on image data of the form read by a scanner, based on the layout information acquired.

2. The form processing system according to claim 1, wherein the OCR device further includes:
an assist generation unit that generates assist information assisting generation of the layout information; and
an assist transmission unit that transmits the assist information to the form creation device,
the form creation device further includes an assist acquisition unit that acquires the assist information transmitted, and
the layout generation unit generates the layout information based on the assist information acquired.

3. The form processing system according to claim 2, wherein the assist information contains algorithm information about an algorithm which is used in an OCR processing unit in the OCR device.

4. The form processing system according to claim 2, wherein the assist generation unit generates reform information that denotes points to be reformed in the acquired layout information based on results of the OCR processing, and
the assist information contains the reform information.

5. The form processing system according to claim 4, wherein the form creation device further includes a reference generation unit that generates reference data serving as a reference for comparison to the results of the OCR processing based on the layout information generated,
the layout transmission unit transmits the reference data to the OCR device,
the OCR device further includes a reference acquisition unit that acquires the reference data transmitted, and
the assist generation unit generates the reform information based on the reference data acquired and the results of the OCR processing.

6. The form processing system according to claim 1, wherein the form creation device further includes a data output unit that outputs the generated layout information to a printer,
the generated layout information contains variable information defining a variable form in which an input region is variable, and
if the data output unit outputs to the printer the layout information having the determined input region in the variable information, the layout transmission unit transmits the layout information having the determined input region to the OCR device.

7. The form processing system according to claim 1, further comprising a printer and an image readout device, wherein the form creation device further includes:
an output control unit that controls, in the case of printing the form by the printer, this printer so that the printer may print under predetermined conditions; and
a readout control unit that specifies a method of operating the image readout device in the case of reading the form in this image readout device.

8. The form processing system according to claim 1, wherein the form creation device further includes:
an unnecessary element determination unit that determines unnecessary image elements among the layout information; and
a referential image generation unit that generates referential image data from which the image elements determined by the unnecessary element determination unit as unnecessary are removed, based on the layout information,
the layout transmission unit transmits the layout information or the referential image data to the OCR device, and
the OCR device further includes an image correction unit that corrects, if having received the referential image data, image data of the form read by the scanner, based on this referential image data.

9. The form processing system according to claim 1, wherein the OCR device further includes:
an unnecessary element determination unit that determines unnecessary image elements among the layout information;
a referential image generation unit that generates referential image data from which the image elements determined by the unnecessary element determination unit as unnecessary are removed, based on the layout information; and
an image correction unit that corrects image data of the form read by the scanner, based on the referential image data.

10. The form processing system according to claim 8, wherein the image elements determined by the unnecessary element determination unit as unnecessary include variable character strings or number strings, dotted lines, broken lines, gray and other color fills, hatchings, pattern images of barcodes, gray and other color image elements, lines thinner than a predetermined rated value, or characters smaller than a predetermined rated value.

11. The form processing system according to claim 9, wherein the image elements determined by the unnecessary element determination unit as unnecessary include variable character strings or number strings, dotted lines, broken lines, gray and other color fills, hatchings, pattern images of barcodes, gray and other color image elements, lines thinner than a predetermined rated value, or characters smaller than a predetermined rated value.

12. The form processing system according to claim 8, wherein the referential image generation unit rasterizes the image elements in the layout information from which the image elements determined by the unnecessary element determination unit as unnecessary are removed.

13. An OCR device comprising:
a layout acquisition unit that acquires layout information denoting a layout of a form transmitted from a form creation device that creates the form; and
an OCR processing unit that performs OCR processing on image data of the form read by a scanner, based on the layout information acquired.

14. A form creation device comprising:
a layout generation unit that generates layout information denoting a layout of a form; and
a layout transmission unit that transmits the layout information generated, to an OCR device that analyzes information written in the form.

15. A non-transitory computer-readable medium storing thereon a computer program used in a computer, the computer program causing the computer to function as:
a layout acquisition unit that acquires layout information denoting a layout of a form transmitted from a form creation device that creates the form; and
an OCR processing unit that performs OCR processing on image data of the form read by a scanner, based on the layout information acquired.

16. A non-transitory computer-readable medium storing thereon a computer program used in a computer, the computer program causing the computer to function as:
a layout generation unit that generates layout information denoting a layout of a form; and
a layout transmission unit that transmits the layout information generated, to an OCR device that analyzes information written in the form.
